(19) United States
(12) Patent Application Publication
(10) Pub. No.: US 2024/0320593 A1
(43) Pub. Date: Sep. 26, 2024

(54) COMPUTERIZED ENTERPRISE MANAGEMENT

(71) Applicant: Wells Fargo Bank, N.A., San Francisco, CA (US)

(72) Inventor: Jonathon Traer Clark, NEW CANAAN, CT (US)

(21) Appl. No.: 18/188,857

(22) Filed: Mar. 23, 2023

(51) Int. Cl. G06Q 10/0637; G06Q 40/03; G06Q 40/04; G06Q 40/06

(52) U.S. Cl. CPC G06Q 10/06375; G06Q 40/03; G06Q 40/04; G06Q 40/06

(57) ABSTRACT

Various examples are directed to a management application. The management application may determine respective net positions for a plurality of time periods. The management application may determine a first positive tranche comprising a portion of the net position for a first time period and a portion of the net position for a second time period. The management application may send a first purchase instruction to an investment system. The first purchase instruction may request purchase of a security having a value corresponding to the first positive tranche and a period comprising at least the first time period and the second time period.

### BACKGROUND

Various computerized tools are used to assist in enterprise management. For example, an enterprise resource planning (ERP) application may be executed at a computing system to manage various different aspects of an enterprise including accounting, human resources, order management and/or the like.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for managing an enterprise.

FIG. 2 is a diagram showing another example of the environment including additional details.

FIG. 3 is a diagram showing a graphical representation of net positions and tranches in an example.

FIG. 4 is a flowchart showing one example of a process flow that may be executed by the management application of FIG. 1.

FIG. 5 is a flowchart showing one example of a process flow that may be executed by the management application of FIG. 1 to generate updated training data for a model.

FIG. 6 is a flowchart showing one example of a process flow that may be executed by the management application of FIG. 1.

FIG. 7 is a block diagram showing one example of a software architecture for a computing device.

FIG. 8 is a block diagram illustrating a computing device hardware architecture within which a set or sequence of instructions can be executed to cause a machine to perform examples of any one of the methodologies discussed herein.

### DETAILED DESCRIPTION

An enterprise may use computerized tools to manage cash flow. For example, an enterprise resource planning (ERP) software tool in conjunction with one or more databases may be used to manage various accounting processes.

An ERP software tool may be used by an enterprise to determine a daily cash position of the enterprise. Daily cash position is an indication of cash on hand at the close of business on a given day. Because of the opportunity cost of holding excess cash (cash that is not being used to generate a return), some enterprises will invest their daily cash position in a security having an overnight term, such as a money market fund. In this way, the cash is available during the next business day should it be needed. The return to an enterprise from an overnight term security, however, may be minimal. Although it may be more favorable for the enterprise to enjoy a small return from an overnight term security than to hold cash, benefit may still be small.

An enterprise may obtain a higher return on its daily cash position by purchasing longer-term securities. This strategy, however, includes certain risks. For example, using a daily cash position to purchase securities with a term longer than overnight involves predicting future daily cash positions for the enterprise. If the predicted future cash positions are incorrect, the enterprise may purchase securities having inappropriate maturity dates, which may result in a negative cash position for the enterprise. When the enterprise experiences negative cash positions, it may incur expenses related to drawing on a line of credit or other means of borrowing.

Using computer-implemented tools to predict future cash positions for an enterprise presents certain challenges. For example, many enterprises have a large number of factors that contribute to their daily cash position including, for example, the opening position on a given day, various corporate actions, factors related to financing, as well as a multitude of accounts receivable, a multitude of accounts payable, and unplanned nonperiodic expenses. In some examples, the sum of all these factors and more contribute to the daily cash position for an enterprise. Accordingly, predicting future daily cash positions involves accurate modeling of the relevant factors.

Further, various factors relating to the daily cash position can change in real time. For example, an accounts receivable due to be paid to the enterprise on a given day may be late. An unexpected, nonperiodic expense may arise due to an unforeseen contingency.

Various examples described herein address these and other challenges utilizing a computer-executed management application. The computer-executed management application may utilize various computerized models such as, for example, an accounts receivable model, an accounts payable model, and/or a nonperiodic expense model. The management application may execute periodically, such as daily. In some examples, the management application may execute in real time. When the management application executes, it may receive record data from an ERP system. The record data received from the ERP system may describe the state of accounts receivable for an enterprise on the day of execution. This may include an indication of accounts receivable that are still outstanding as well as, for example, an indication of accounts receivable that have been paid since the last running of the management application.

The management application may be configured to extract, from the accounts receivable data, updated training data for training the accounts receivable model. The accounts receivable model may be initially trained using a suitable set of training data. The management application, upon receiving accounts receivable data, may be configured to generate updated training data by extracting the updated training data from the accounts receivable data. For example, the management application may be configured to generate accounts receivable training data items based on the accounts receivable that are indicated to be paid or not paid for a given day. The updated training data is used to retrain the accounts receivable model. The management application then executes the retrained accounts receivable model to generate predicted cash input positions for the enterprise over a number of days (or other suitable time periods) into the future.

During its execution, the management application may also receive accounts payable data indicating accounts payable for the enterprise. In some examples, the management application may utilize an accounts payable model. In some examples utilizing an accounts payable model, the management application may be configured to retrain the accounts payable model by extracting updated training data items for the accounts payable model. The management application may execute the accounts payable model to generate respective cash output positions or the enterprise over the number of days or other suitable time periods.

The management application may use the predicted cash input positions and the predicted cash output positions to determine a predicted net position for the number of days or other suitable time periods in the future. For example, each day of the number of days may have a predicted cash input position and a predicted cash output position. A position for each day may be the difference between the cash input position for that day and the cash output position for that day.

Upon determining the net position for the number of days in the future, the management application may be configured to identify positive tranches that extend over multiple days. Consider an example in which the predicted net position for Monday is $100 and the predicted net position for Tuesday is $50. In this example, the management application may identify a positive tranche of $50 that is available on both Monday and Tuesday.

When the management application identifies a positive tranche that extends over multiple days, the management application may send an instruction to an investment system to purchase a security having a term corresponding to the number of days or other time periods that the tranche exists. A security having a longer term, as described herein, may tend to also produce a higher return. Therefore, the enterprise executing management application may increase return on its daily cash position by taking advantage of longer-term securities when said longer-term securities are a practical option.

It will be appreciated, however, that the returns obtained by the enterprise may depend on the accuracy of the computerized models, including the accounts receivable model. For example, if the actual cash input for a given time period is lower than what is predicted by the accounts receivable model, the enterprise may experience a negative net position which, as described herein, may incur borrowing expenses. The borrowings expenses may reduce and, in some cases, exceed the increased revenue to the enterprise from the purchase of the longer-term security.

In various examples, the training and retraining of one or more of the computerized models, as described herein, may increase the accuracy of the models, thereby facilitating the purchase of longer-term securities and/or credit products.

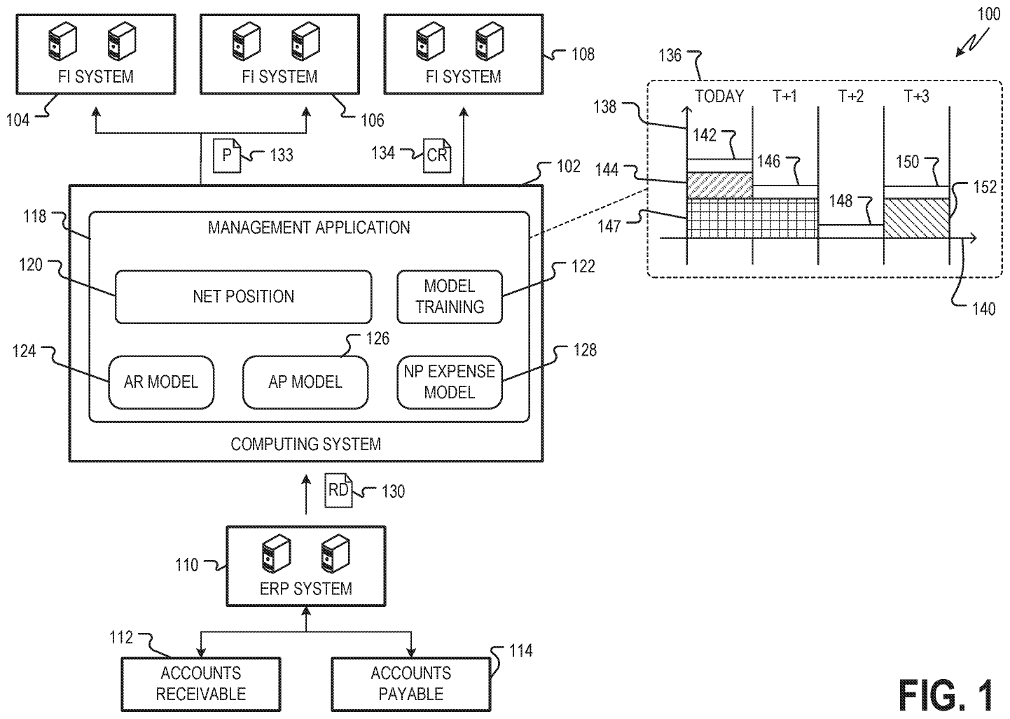

FIG. 1 is a diagram showing one example of an environment 100 for managing an enterprise. The environment 100 includes a management computing system 102 executing a management application 118. The management computing system 102 may be any suitable type of computing system. For example, the management computing system 102 may comprise one or more servers or other suitable computing devices positioned at a common geographic location or distributed across multiple geographic locations. For example, in some examples, the management computing system 102 may be implemented in a cloud environment and/or in an on-premise environment. In some examples, the management application 118 may be and/or may be in communication with a treasury management system, a bank gateway system, and/or the like.

The management computing system 102 may be in communication with various other systems and/or software packages. For example, the management computing system 102 may be in communication with an enterprise resource planning (ERP) system 110. The ERP system 110 may execute an ERP application that may manage various aspects of the operation of an enterprise, such as accounts receivable, accounts payable, payroll, and/or the like. The ERP system 110 may comprise one or more computing devices located at a common geographic location and/or distributed across multiple geographic locations. The ERP system 110 may be implemented in an on-premise and/or cloud environment. In some examples, the ERP system 110 and the management computing system 102 are implemented in common. For example, a single computing system, such as the management computing system 102, may execute the management application 118 and an ERP application.

The ERP system 110 may access various data stores including data utilized by the management application 118 as described herein. For example, the ERP system 110 may access an accounts receivable data store 112, and/or an accounts payable data store 114. The accounts receivable data store 112 may comprise data describing accounts receivable of the enterprise. For example, the accounts receivable data store 112 may store records, where each record describes an account receivable of the enterprise. The record for an account receivable may indicate various information about the account receivable such as, for example, the counterparty for the account receivable (the party that is to pay the accounts receivable to the enterprise), the date that the account receivable was created, whether the account receivable has been paid, when the account receivable was paid, an amount of the account receivable that has been paid, and/or the like.

An accounts payable data store 114 may also, in some examples, be maintained by the ERP system 110. The accounts payable data store 114 may comprise records describing accounts payable for the enterprise. The record for an account payable may indicate various information about the account payable such as, for example, the counterparty for the account payable (the party to whom the enterprise will pay), the date that the account payable was created, the date on which the account payable is due, the date on which the enterprise plans to pay the account payable, an amount of the account payable, whether the account payable has been paid, an amount of the account payable that was paid, and/or the like.

The enterprise resource planning system 110 may provide record data 130 to the management application 118 as described herein. Record data 130 may include, for example, accounts receivable data obtained from the accounts receivable data store 112 and accounts payable data obtained from the accounts payable data store 114.

The management computing system 102 may also be in communication with various financial institution systems 104, 106, 108. Financial institution systems 104, 106, 108 may include one or more computing devices and/or other components for managing all or part of a financial institution. Management application 118, via the management computing system 102, may be configured to send one or more instructions to the various financial institution systems 104, 106, 108.

In some examples, the management application 118 may send a purchase instruction 133 to one or more of the financial institution systems 104, 106, 108. The purchase instruction 133 may cause and/or initiate the purchase of a security managed by the financial institution associated with the respective financial institution system 104, 106, 108. In some examples, as described herein, the purchased security may have a term that is longer than one day. In some examples, the purchase instruction 133 may instruct the purchase of additional shares in an account or other security that is already owned by the enterprise.

In some examples, the management application 118 may send a credit request 134 to one or more of the financial institution systems 104, 106, 108. The credit instruction may cause and/or initiate access to a credit product from the financial institution associated with the respective financial institution system 104, 106, 108. In some examples, as described herein, the credit product may have a term that is longer than one day. In some examples, the credit instruction may initiate access to a new credit product, such as a new loan. In other examples, the credit instruction may initiate access to a previously-existing credit product such as, for example, a line of credit accessible to the enterprise.

The management application 118, as described herein, may implement components and techniques that facilitate the purchasing of securities and/or accessing of credit product having a term greater than one day using the daily (or other periodic) cash position of the enterprise. For example, the management application 118 may comprise various components, including a net position subsystem 120, a model training subsystem 122, an accounts receivable model 124, an accounts payable model 126, and/or a nonperiodic expense model 128.

The accounts receivable model 124 may be any suitable type of computerized model. In some examples, the accounts receivable model 124 is a classification model that returns, for each account receivable and day or other time period, an indication of whether the account receivable is paid or unpaid. Other example types of computerized model may include, for example, other supervised learning models.

Classification models and regression models are both examples of supervised learning models. Supervised learning models train a computerized model on independent variables (e.g., fund transfer parameter values) and dependent variables (e.g., success or failure of the fund transfer). Classification models may be useful in situations where the dependent variable is binary or may take only a range of discrete values. For example, when the accounts receivable model 124 is a classification model, the result of the accounts receivable model 124 may include a binary (e.g., likely success or likely failure). Regression models, on the other hand, utilize a dependent variable that is continuous. For example, when a regression model is used, instead of indicating that values for the set of fund transfer parameters are likely to succeed or fail, the regression model may return raw scores for a set of fund transfer parameter values, with the raw scores indicating the percentages probability that a fund transfer with the corresponding set of fund transfer parameter values would be successful.

Some machine learning models have both classification and regression implementations. For example, the K-Nearest Neighbors model may be implemented as either a classification model or a regression model. Other models may be more suitable for one implementation or the other. For example, the Ordinary Least Squares model may be most suitable for a regression implementation. Also, the Logistic Regression model may be most suitable for a classification implementation.

The examples herein are described for use with classification models. In various examples, however, in some examples, it may be useful or desirable to utilize a set of regression models in place of the set of classification models. Accordingly, the systems and methods described herein may also be implemented utilizing a set of classification models, a set of regression models, a mixed set of supervised learning models including classification models and regression models, etc. The accounts payable model 126 and nonperiodic expense model 128 may also, in some examples, be supervised learning models. In some examples, the accounts payable model 126 and/or the expense model 128 may be or include various other computerized models such as, for example, a forecasting model, a credit model, a discounted cash flow model, a historical behavior model, and/or the like.

The model training subsystem 122 may be configured to train and/or retrain the various models 124, 126, 128. For example, the model training subsystem 122 may receive and/or access accounts receivable data from the ERP system 110. The model training subsystem 122 may be programmed to extract training data items from the accounts receivable data, for example, as described herein. For example, initially, the model training subsystem 122 may receive accounts receivable data describing accounts receivable over a suitable range of days or other time periods (e.g., a quarter, a year, multiple years, and/or the like). The model training subsystem 122 may extract from the accounts receivable data a set of training data items. Each training data item may describe the state of an account receivable including, for example, the date on which the account receivable was opened, an amount of the account receivable, a counter party of the account receivable, and a date on which the account receivable was paid or otherwise fulfilled. Model training subsystem 122 may utilize the extracted training data items to train and/or retrain the accounts receivable model 124.

The model training subsystem 122 may also extract training data items for the accounts payable model 126 from accounts payable data received by the ERP system 110. For example, initially, the model training subsystem 122 may receive accounts payable data describing accounts payable over suitable range of days or other time periods (e.g., a quarter, a year, multiple years, and/or the like). The model training subsystem 122 may extract from the accounts payable data a set of training data items. Each training data item may describe the state of an account payable including, for example, the date on which the account payable was opened, an amount of the account payable, a counter party of the account payable, and a date on which the account payable was paid or otherwise fulfilled. Model training subsystem 122 may utilize the extracted training data items to train and/or retrain the accounts receivable model 124.

In some examples, the model training subsystem 122 may also train and/or retrain the nonperiodic expense model 128. Nonperiodic expense model 128 may predict nonperiodic expenses for the enterprise. The nonperiodic expenses for the enterprise, in some examples, may be caused by unexpected events such as, for example, natural disasters, equipment failures, force majeure events, and/or the like.

In some examples, the model training subsystem 122 may extract nonperiodic expense training data from the accounts payable data received from the ERP system 110. For example, the model training subsystem 122 may analyze accounts payable data to identify accounts payable that are attributable to nonperiodic expenses. For example, the model training subsystem 122 may be programmed to recognize expenses that are periodic or recurring (represented by accounts payable that are periodic or recurring). Accounts payable that are not associated with events that are periodic or recurring may be nonperiodic expenses. The model training subsystem 122 may generate training data items for the nonperiodic expense model 128 from the accounts payable data describing nonperiodic expenses. For example, a training data item for the nonperiodic expense model 128 may indicate an amount of the expense, a time at which the expense was incurred, as well as other information about the expense such as, for example, a location where the expense was incurred, and/or the like.

The net position subsystem 120 may be programmed to determine net positions for the enterprise over a plurality of days or other time periods. In some examples, the management application 118, including the net position subsystem 120, is configured to execute periodically. For example, the net position subsystem 120 may execute at a point in time during each of a plurality of time periods. Consider an example plurality of time periods comprising the days of the week. In this example, the management application 118 may execute at a point in time during the first time period (e.g., Monday), may execute again at a point in time during the second time period (e.g., Tuesday), may execute again at a point in time during the third time, (e.g., Wednesday), and so on. In other examples, the management application 118 may be configured to execute every day, every week, every quarter, and/or the like.

Each time that the management application 118 executes, the net position subsystem 120 may generate predicted net positions for the enterprise over a plurality of days or other suitable time periods. For example, the net position subsystem 120 may generate, for each considered time period, a cash output position and a cash input position. The cash input position may represent the cash that the enterprise is predicted to receive in the corresponding time period. The cash output position is the cash that the enterprise is expected to pay out at the corresponding time period. The net of the cash input position and the cash output position for a time period may be the predicted net position for the time period.

The net position subsystem 120 may generate the predicted net positions for the enterprise using the accounts receivable model 124, the accounts payable model 126, and the nonperiodic expense model 128. For example, the net position subsystem 120 may access accounts receivable data and accounts payable data from the ERP system 110. The net position subsystem 120 may execute the accounts receivable model 124 using some or all of the accounts receivable data as input. In response, the accounts receivable model 124 may generate a predicted cash input position for each considered time period.

Net position subsystem 120, in some examples, may utilize a combination of output of the nonperiodic expense model 128, output of the accounts payable model 126, and accounts payable data received from the ERP system 110 to generate the cash output position for a time period. In some examples, the net position subsystem 120 may execute the nonperiodic expense model 128 to predict one or more nonperiodic expenses that are predicted to occur in one or more of the plurality of time periods considered. A predicted nonperiodic expense in a given time period is added to the cash output position for that time period.

The nonperiodic expense model 128 may be trained utilizing nonperiodic expense data that describes nonperiodic expenses. In some examples, the nonperiodic expense data may be retrieved from the ERP system 110. Also, for example, the nonperiodic expense data may describe previous nonperiodic expenses incurred by the enterprise and/or may describe previous nonperiodic expenses incurred by other enterprises. The model training subsystem 122 may use the nonperiodic expense data to train the nonperiodic expense model 128 to return predicted nonperiodic expenses.

The cash output position for a given time period may also consider accounts payable that are due to be paid during that time period. In some examples, the net position subsystem 120 may receive accounts payable data from the ERP system 110 where the accounts payable data indicates the dates on which various accounts payable will be paid by the enterprise. The net position subsystem 120 may add accounts payable to the cash output position in the respective time periods in which the accounts payable will be paid. In some examples, the net position subsystem 120 may execute the accounts payable model 126. The accounts payable model 126 may receive accounts payable data, for example, from the ERP system 110. Based, at least, on the accounts payable data, the accounts payable model 126 may generate a predicted pay date for one or more accounts payable. The net position subsystem 120 may add accounts payable to the cash output position in the respective time periods at which the model predicts that the accounts payable will be paid.

The net position subsystem 120 may generate respective net positions for the enterprise across the plurality of time periods. For example, the net position subsystem 120 may generate a first net position corresponding to a first time period, a second net position corresponding to a second time period, a third net position corresponding to a third time period, and so on.

Upon determining the positions corresponding to the plurality of time periods, the net position subsystem 120 may identify one or more tranches that exist across multiple consecutive time periods. Tranches, in various examples, may be positive or negative. When the net position subsystem 120 identifies a positive tranche existing across multiple consecutive time periods, it may send a purchase instruction 133 to a financial institution system 104, 106, 108. The purchase instruction 133 may instruct the purchase of a security having a value that corresponds to the positive tranche and a term that comprises at least a portion of the multiple consecutive time periods over which the positive tranche exists. In some examples, the net position subsystem 120 may send purchase instructions 133 for positive tranches that begin at a current time period. Also, in some examples, the net position subsystem 120 may send purchase instructions 133 for positive tranches that begin at a future time period. Purchase instructions for positive tranches that begin at a future time period may request that the security be purchased in the future time period at which the positive tranche begins.

In some examples, the net position subsystem 120 may determine that a negative tranche exists across multiple time periods. This may occur, for example, if the net position for the enterprise is negative for multiple consecutive time periods. When the net position subsystem 120 identifies a negative tranche existing across multiple consecutive time periods, it may send a credit instruction to a financial institution system 104, 106, 108. The credit instruction may request a credit amount corresponding to the negative tranche and a credit term comprising at least a portion of the multiple consecutive time periods over which the negative tranche exists. In some examples, the net position subsystem 120 may send credit requests 134 for negative tranches that begin at a current time period. Also, in some examples, the net position subsystem 120 may send credit requests 134 for negative tranches that begin at a future time period. Credit requests for negative tranches that begin at a future time period may request that the security be purchased in the future time period at which the negative tranche begins.

FIG. 1 also shows a breakout window 136 showing a graphical representation of net positions and tranches in one example. The breakout window 136 shows a horizontal axis 140 indicating time and a vertical axis 138 indicating net position. The horizontal axis 140 shows four time periods: a time period labeled TODAY, a time period labeled T+1, a time period labeled T+2, and a time period labeled T+3.

Breakout window 136 shows a positive tranche 147 that exists across TODAY and T+1. A second positive tranche 144 exists in the time period TODAY, but does not exist into the next time period T+1. A third positive tranche 152 exists in the time period T+3.

In this example, the management application 118 executed at a point in time that is either prior to or during the time period TODAY. The management application 118 may send a purchase instruction 133 requesting the purchase of a security having an amount equal to the amount of the positive tranche 147 and having a term that includes the time period of the time period TODAY and the time period T+1. Also, the management application 118 may send a purchase instruction 133 requesting the purchase of the security having an amount equal to the amount of the positive tranche 144 and a term that includes the time period TODAY. In some examples, the management application 118 may also send a purchase instruction 133 requesting the purchase of a security corresponding to the positive tranche 152 at the time period T+3. In other examples, the management application 118 may re-execute at a point in time before or during the time period T+3 and send a purchase instruction 133 in that subsequent execution.

The breakout window 136 also illustrates example reserve amounts 142, 146, 148, 150. The reserve amounts 142, 146, 148, 150 may indicate an amount of the net position for a given day that is to be kept on hand (e.g., that is not used to purchase a security). In some examples, the management application 118 may determine the reserve amount 142, 146, 148, 150 for a given time period as a fixed amount and/or a percentage of the net precision for that time period.

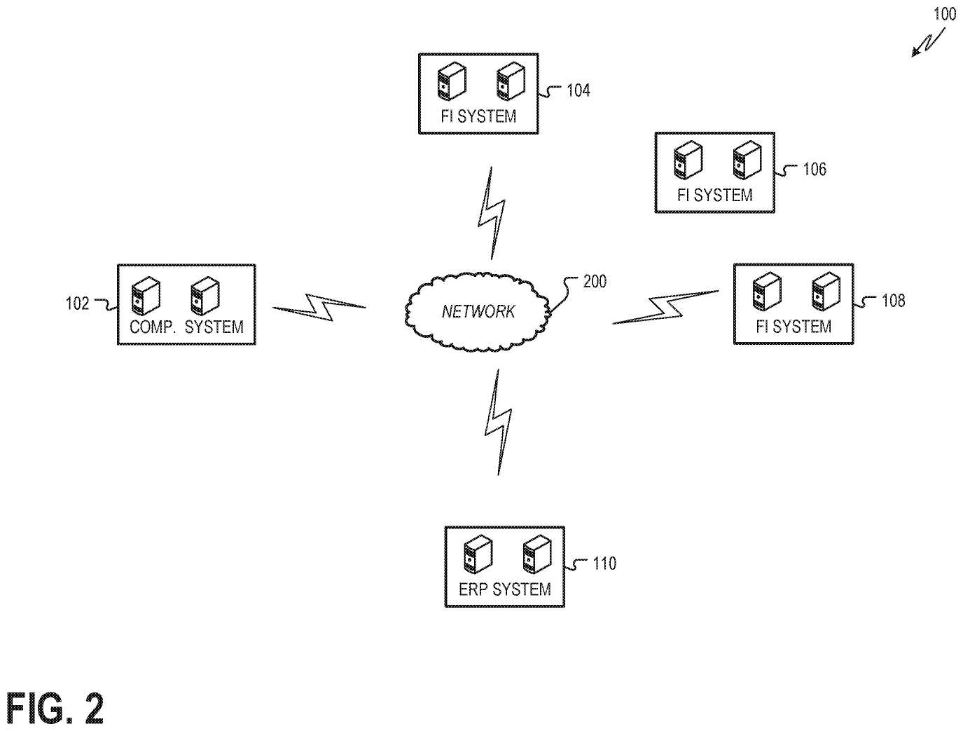

FIG. 2 is a diagram showing another example of the environment 100 including additional details. In the example of FIG. 2, the financial institution systems 104, 106, 108, the management computing system 102, and the ERP system 110 are in communication with one another via a network 200. The network 200 may be or comprise any suitable network element operated according to any suitable network protocol. For example, one or more portions of the network 200 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, a combination of two or more such networks, and so forth.

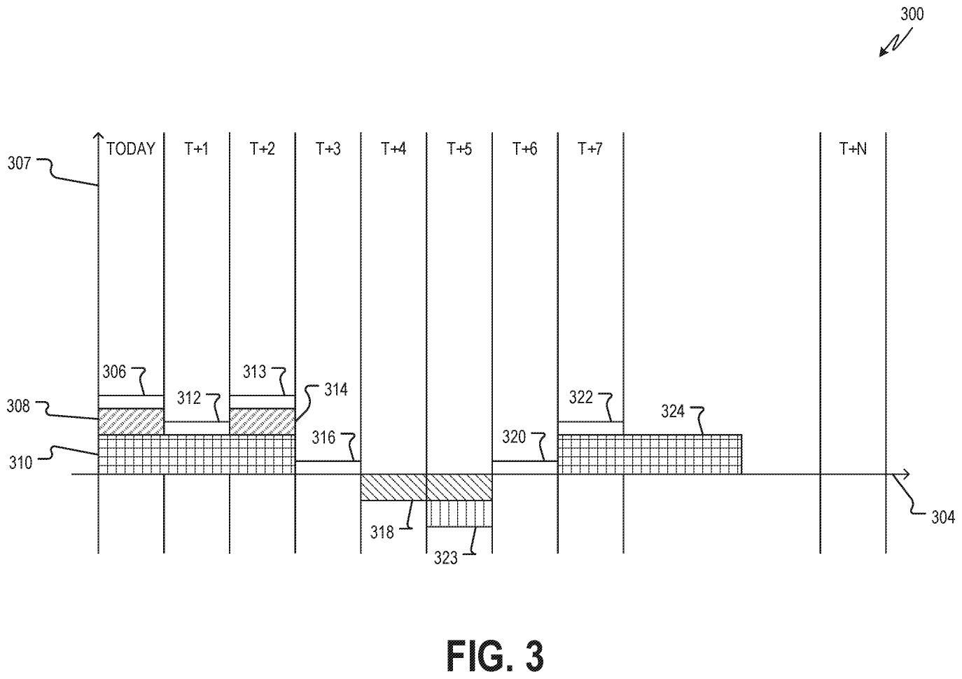

FIG. 3 is a diagram 300 showing a graphical representation of net positions and tranches in an example. The diagram 300 comprises a horizontal axis 304 indicating time and a vertical axis 307 indicating net position. The horizontal axis 304 shows time periods labeled TODAY, T+1, T+2, T+3, T+4, T+5, T+6, T+7, and T+N. In the example of FIG. 3, the management application 118 executed at a point in time that is before or during the time period TODAY.

In the example of the diagram 300, a positive tranche 310 exists across TODAY, T+1, and T+2. The management application 118 may identify the positive tranche 310 and, in response, send the purchase instruction 133 to a financial institution system 104, 106, 108. Purchase instruction 133 may instruct the purchase of a security having a value that corresponds to an amount of the positive tranche 310 and have a term including the periods TODAY, T+1, and T+2.

The diagram 300 also shows additional positive tranches 308, 314, 324. The positive tranche 308 exists in the time period TODAY. The positive tranche 314 exists in the time period T+2. The positive tranche 324 exists at the time period T+7 and extends forward in time towards the time period T plus N. In this example, the management application 118 may send a purchase instruction 133 in the time period TODAY to purchase a security having an amount corresponding to the tranche 308 and a term corresponding to the period TODAY. In some examples, the management application 118 may also, at the period TODAY, send a purchase instruction 133 to a financial institution system 104, 106, 108 instructing the purchase of a securities responding to the positive tranches 314, 324. In other examples, the management application 118 may defer a purchase instruction 133 for the positive tranches 314, 324 until it executes at a later point in time, for example at the respective time periods when the tranches 314, 324 begin to exist.

The diagram 300 also shows example negative tranches 318, 323. Negative tranches 318, 323 exist at time periods T+4 and T+5 at which the net position for the enterprise is negative. In some examples, the management application 118 may send a credit request 134 for the negative tranches 318. The credit request 134 may describe a request for credit having a term including the time periods T+4 and T+5 and an amount corresponding to the negative tranche 318. The management application 118 may also send a credit request 134 for the negative tranche 323. The credit request 134 for the negative tranche 323 may describe a request for credit having a term including the time period T+5 an amount corresponding to the negative tranche 323. In some examples, credit instructions for the respective negative tranches may be sent by the management application 118 when the negative tranches are determined (e.g., in this example at the time period TODAY). Also, in some examples, credit instructions for respective negative tranches may be sent at the first time period during which credit would be needed. For example, a credit request 134 corresponding to the negative tranche 318 may be sent during an execution of the management application 118 corresponding to the time period T+4 and a credit request 134 for the negative tranche 323 may be sent during an execution of the management application 118 corresponding to the time period T+5.

The diagram 300 also illustrates example reserve amounts 306, 312, 313, 316, 320, 322. The reserve amounts 306, 312, 313, 316, 320, 322 may indicate an amount of the net position for a given day that is to be kept on hand (e.g., that is not used to purchase a security). For example, as described herein, the management application 118 may determine tranches that leave a reserve amount, such as the reserve amounts 306, 312, 313, 316, 320, 322.

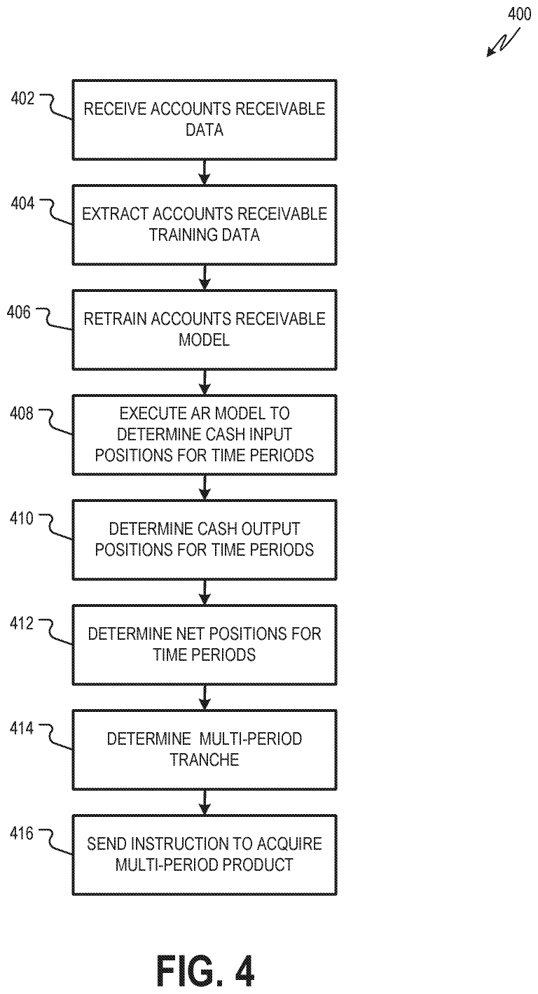

FIG. 4 is a flowchart showing one example of a process flow 400 that may be executed by the management application 118. The process flow 400 describes one execution of the management application 118. For example, the management application 118 may execute the process flow 400 at one point in time per time period.

At operation 402, the management application 118 may receive accounts receivable data describing state of accounts receivable for an enterprise. As described herein, the accounts receivable data may indicate at least one account receivable that was paid during the current time period. At operation 404, the management application 118 may extract accounts receivable training data from the accounts receivable data. This may include determining one or more training data items from the accounts receivable data to generate updated training data. At operation 406, the management application 118 may retrain the accounts receivable model 124 using the updated training data.

At operation 408, the management application 118 may execute the retrained accounts receivable model to determine respective cash input positions for a plurality of time periods. For example, the management application 118 may determine a first cash input position for a first time period, a second cash input position for a second time period, a third cash input position for a third time period, and so on.

At operation 410, the management application 118 may determine respective cash output positions for the plurality of time periods. This may include receiving accounts payable data from the ERP system 110. In some examples, it includes executing the accounts payable model 126 using the accounts payable data. Also, in some examples, determining the respective cash output positions for the plurality of time periods includes executing the nonperiodic expense model 128. Results of executing the nonperiodic expense model 128 may include a prediction of zero or more nonperiodic events during one or more of the plurality of time periods.

At operation 412, the management application 118 may determine respective net positions or the plurality of time periods. This may include, for each time period, summing the cash input position and the cash output position. At operation 414, the management application 118 may determine a multiperiod tranche. The multiperiod trench may exist over more than one of the plurality of periods, and may be positive or negative. In various examples, the management application 118 may determine more than one multiperiod tranche if more than one multiperiod tranche exists.

At operation 416, the management application 118 may send an instruction to a financial institution system 104, 106, 108 to acquire a multiperiod product. For example, as described herein, the management application 118 may send a purchase instruction 133 corresponding to a positive multiperiod tranche and may send a credit request 134 corresponding to a negative multiperiod tranche. In some examples, the management application may send multiple instructions. For example, if more than one multiperiod tranche begins in a current time period, management application 118 may send an instruction for each tranche. Also, in some examples, the management application 118 may also send one or more instructions for single-period tranches beginning at the currently considered time period.

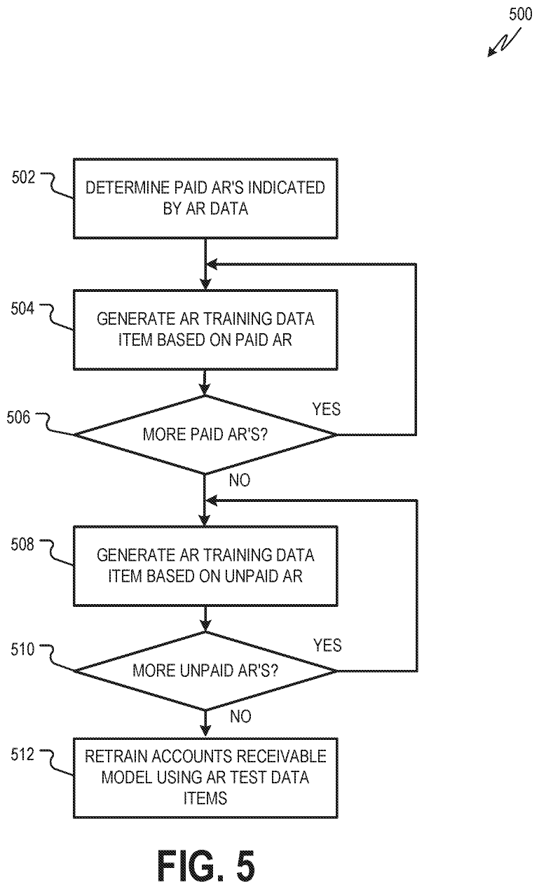

FIG. 5 is a flowchart showing one example of a process flow 500 that may be executed by the management application 118 to generate updated training data for a model, such as the accounts receivable model 124. At operation 502, the management application 118 may examine received accounts receivable data to determine accounts receivable that are indicated by the accounts receivable data to be paid. At operation 504, the management application 118 may generate an accounts receivable training data item based on a first paid accounts receivable. The accounts receivable training data item based on a paid account receivable may indicate, for example, an amount of the paid account receivable, a date on which the paid account receivable was issued, a date on which the paid account receivable was paid, the counterparty for the account receivable, and/or the like.

At operation 506, the management application 118 determines if there are any additional paid accounts receivable indicated by the accounts receivable data. If there are additional paid accounts receivable, the management application 118 may return to operation 504 and generate an accounts receivable training data item based on the next paid account receivable.

When no more paid accounts receivable remain, the management application 118, at operation 508, may generate an accounts receivable training data item based on an unpaid account receivable indicated by the accounts receivable data. An accounts receivable training data item based on an unpaid account receivable may include, for example, the date on which the account receivable was issued, an indication of the counterparty, an indication of an amount of the account receivable, and/or the like.

If there are additional unpaid account receivable at operation 510, the management application 118 may return to operation 508 and generate an accounts receivable training data item based on the next unpaid account receivable indicated by the account receivable data. When there are no more unpaid accounts receivable at operation 510, the management application 118 may retrain the accounts receivable model 124, at operation 512, using updated training data that comprises the accounts receivable training data items generated.

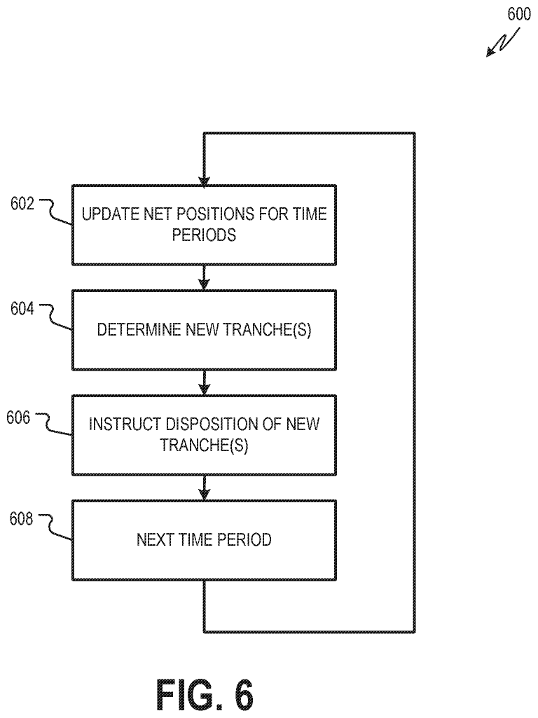

FIG. 6 is a flowchart showing one example of a process flow 600 that may be executed by the management application 118. Process flow 600 shows an example way that the management application 118 may execute to update predicted net positions that have been previously determined, for example, by a previous execution of the management application 118 at a previous point in time.

At operation 602, the management application 118 may update net positions for a plurality of time periods. Updating net positions for a plurality of time periods may include generating new cash input and the cash output positions for the respective time periods, for example, as described herein. At operation 604, the management application 118 may determine tranches. The new tranches may be the same as tranches generated during a previous execution of the management application 118 and/or different tranches. For example, the management application 118 may receive new accounts receivable data, accounts payable data, nonperiodic expense data, and/or the like that changes the net positions, and therefore the tranches, over the various time periods. Also, for example, the management application 118 may re-execute the accounts receivable model 124 after retraining the accounts receivable model 124. Upon retraining, in some examples, the accounts receivable model 124 may provide results different than what were provided in a previous time period prior to retraining.

At operation 606, the management application 118 may instruct the disposition of and/or update tranches. In some examples, this involves sending suitable purchase and/or credit instructions for the current time period. In examples in which the management application 118 sends a purchase instruction and/or credit request for future time periods, instructing the disposition of new tranches may include revising previously sent purchase and/or credit instructions based on newly determined tranches and or tranches that have changed. At operation 608, the management application 118 may move to the next time period and may re-execute at operation 602. For example, the management application 118 may re-execute at the new time period.

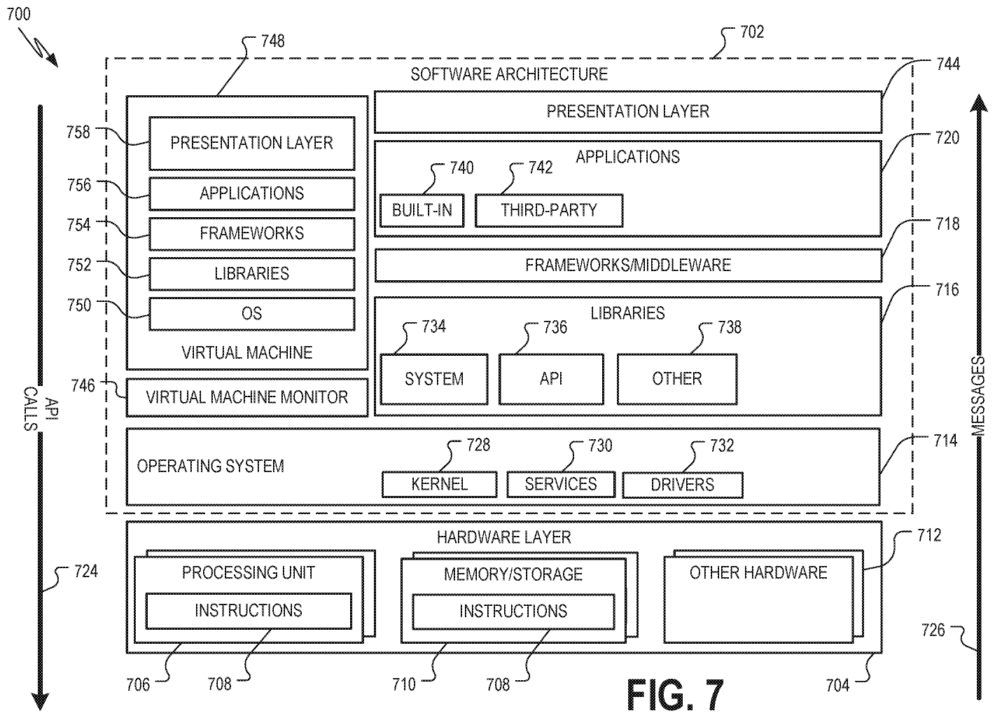

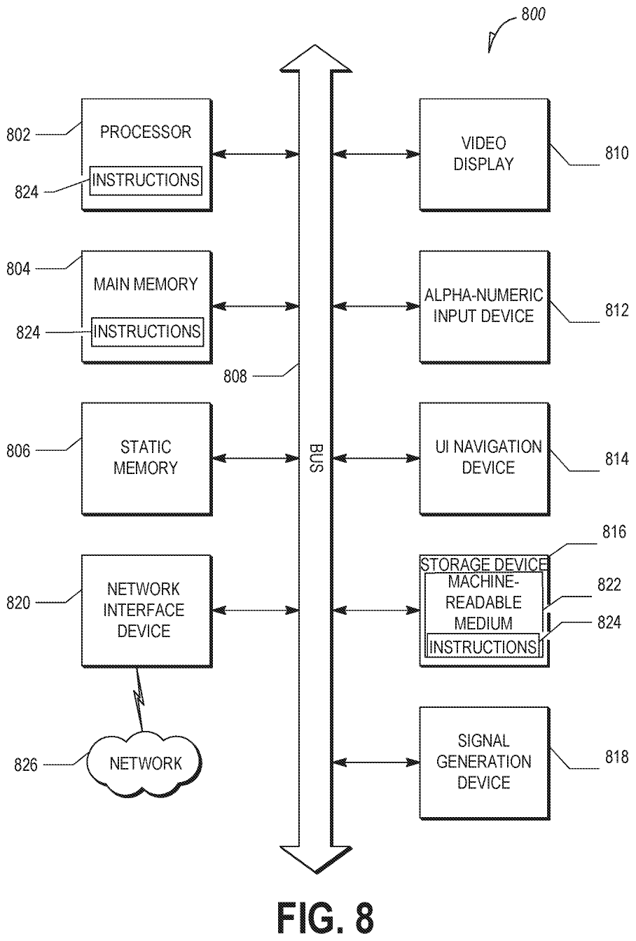

FIG. 7 is a block diagram 700 showing one example of a software architecture 702 for a computing device. The software architecture 702 may be used in conjunction with various hardware architectures, for example, as described herein. FIG. 7 is merely a non-limiting example of a software architecture 702, and many other architectures may be implemented to facilitate the functionality described herein. A representative hardware layer 704 is illustrated and can represent, for example, any of the above-referenced computing devices. In some examples, the hardware layer 704 may be implemented according to an architecture 800 of FIG. 8.

The representative hardware layer 704 comprises one or more processing units 706 having associated executable instructions 708. The executable instructions 708 represent the executable instructions of the software architecture 702, including implementation of the methods, modules, components, and so forth of FIGS. 1-6. The hardware layer 704 also includes memory and/or storage modules 710, which also have the executable instructions 708. The hardware layer 704 may also comprise other hardware 712, which represents any other hardware of the hardware layer 704, such as the other hardware illustrated as part of the architecture 800.

In the example architecture of FIG. 7, the software architecture 702 may be conceptualized as a stack of layers where each layer provides particular functionality. For example, the software architecture 702 may include layers such as an operating system 714, libraries 716, middleware layer 718, applications 720, and a presentation layer 744. Operationally, the applications 720 and/or other components within the layers may invoke application programming interface (API) calls 724 through the software stack and receive a response, returned values, and so forth illustrated as messages 726 in response to the API calls 724. The layers illustrated are representative in nature and not all software architectures have all layers. For example, some mobile or special-purpose operating systems may not provide a middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of a hardware or software interrupt and, in response, cause the software architecture 702 to pause its current processing and execute an interrupt service routine (ISR) when an interrupt is received. The ISR may generate an alert.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, and/or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The middleware layer 718 (also sometimes referred to as frameworks) may provide a higher-level common infrastructure that may be utilized by the applications 720 and/or other software components/modules. For example, the middleware layer 718 may provide various graphical UI functions, high-level resource management, high-level location services, and so forth. The middleware layer 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. The third-party applications 742 may include any of the built-in applications 740 as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 742 may invoke the API calls 724 provided by the mobile operating system such as the operating system 714 to facilitate functionality described herein.

The applications 720 may utilize built-in operating system functions (e.g., kernel 728, services 730, and/or drivers 732), libraries (e.g., system libraries 734, API libraries 736, and other libraries 738), or middleware layer 718 to create UIs to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 7, this is illustrated by a virtual machine 748. A virtual machine creates a software environment where applications/modules can execute as if they were executing on a hardware computing device. The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks/middleware 754, applications 756, and/or a presentation layer 758. These layers of software architecture executing within the virtual machine 748 can be the same as corresponding layers previously described or may be different.

FIG. 8 is a block diagram illustrating a computing device hardware architecture 800 within which a set or sequence of instructions can be executed to cause a machine to perform examples of any one of the methodologies discussed herein. The architecture 800 may describe, for example, any of the computing devices and/or control circuits described herein. The architecture 800 may execute the software architecture 702 described with respect to FIG. 7. The architecture 800 may operate as a standalone device or may be connected (e.g., networked) to other machines. In a networked deployment, the architecture 800 may operate in the capacity of either a server or a client machine in server-client network environments, or it may act as a peer machine in peer-to-peer (or distributed) network environments. The architecture 800 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 800 includes a processor unit 802 comprising at least one processor (e.g., a central processing unit (CPU), a graphics processing unit (GPU), or both, processor cores, compute nodes, etc.). The architecture 800 may further comprise a main memory 804 and a static memory 806, which communicate with each other via a link 808 (e.g., a bus). The architecture 800 can further include a video display unit 810, an alphanumeric input device 812 (e.g., a keyboard), and a UI navigation device 814 (e.g., a mouse). In some examples, the video display unit 810, alphanumeric input device 812, and UI navigation device 814 are incorporated into a touchscreen display. The architecture 800 may additionally include a storage device 816 (e.g., a drive unit), a signal generation device 818 (e.g., a speaker), a network interface device 820, and one or more sensors (not shown), such as a GPS sensor, compass, accelerometer, or other sensor.

In some examples, the processor unit 802 or another suitable hardware component may support a hardware interrupt. In response to a hardware interrupt, the processor unit 802 may pause its processing and execute an ISR, for example, as described herein.

The storage device 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804, within the static memory 806, and/or within the processor unit 802 during execution thereof by the architecture 800, with the main memory 804, the static memory 806, and the processor unit 802 also constituting machine-readable media. The instructions 824 stored at the machine-readable medium 822 may include, for example, instructions for implementing the software architecture 702, instructions for executing any of the features described herein, etc.

While the machine-readable medium 822 is illustrated in an example to be a single medium, the term “machine-readable medium” can include a single medium or multiple media (e.g., a centralized or distributed database, and/or associated caches and servers) that store the one or more instructions 824. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 7G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 77 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A computing system, comprising:
at least one processor programmed to perform operations comprising:
receiving, by a management application executing at the at least one processor, first accounts receivable data describing accounts receivable at a first point in time, the first accounts receivable data comprising an indication that a first account receivable was paid as of the first point in time;
extracting, by the management application and from the first accounts receivable data, updated training data for an accounts receivable model;
retraining, by the management application, the accounts receivable model using the updated training data;
after retraining the accounts receivable model, executing, by the management application, the accounts receivable model based on the first accounts receivable data to determine respective cash input positions for a plurality of time periods, the plurality of time periods being after the first point in time;
receiving, by the management application, first accounts payable data describing accounts payable at the first point in time;
determining, by the management application, respective cash output positions for the plurality of time periods using the first accounts payable data;
determining, by the management application, respective net positions for the plurality of time periods using the respective cash input positions and the respective cash output positions, a net position for a first time period of the plurality of time periods being positive, and a net position for a second time period of the plurality of time periods being positive;
determining, by the management application, a first positive tranche, the first positive tranche comprising a portion of the net position for the first time period and a portion of the net position for the second time period; and
sending, by the management application, a first purchase instruction to an investment system, the first purchase instruction requesting purchase of a security having a value corresponding to the first positive tranche and a period comprising at least the first time period and the second time period.

2. The computing system of claim 1, a net position for a third time period being negative and a net position for a fourth time period after the third time period being negative.

3. The computing system of claim 2, the operations further comprising:
determining, by the management application, a first negative tranche, the first negative tranche comprising a portion of the net position for the third time period and a portion of the net position for the fourth time period; and
sending, by the management application, a first loan instruction, the first loan instruction requesting a credit amount corresponding to the first negative tranche and a credit period comprising at least the third time period and the fourth time period.

4. The computing system of claim 1, the determining of the respective cash output positions for the plurality of time periods comprising executing an accounts payable model.

5. The computing system of claim 4, the operations further comprising:
extracting, by the management application and from the first accounts payable data, updated accounts payable training data for the accounts payable model; and
retraining, by the management application, the accounts payable model using the updated accounts payable training data, the executing of the accounts payable model being after the retraining.

6. The computing system of claim 1, the operations further comprising:
receiving, by the management application, nonperiodic expense data describing at least one nonperiodic expense;
training, by the management application, a nonperiodic expense model using the nonperiodic expense data; and
executing, by the management application, the nonperiodic expense model to determine respective nonperiodic expense positions for the plurality of time periods, the respective net positions for the plurality of time periods also using the respective nonperiodic expense positions.

7. The computing system of claim 1, the operations further comprising:
determining, by the management application, a second positive tranche, the second positive tranche comprising a second portion of the net position for the first point in time; and
sending, by the management application, a second purchase instruction to the investment system, the second purchase instruction requesting purchase of a second security having a value corresponding to the second positive tranche and a term comprising the first time period.

8. The computing system of claim 1, the operations further comprising:
receiving, by the management application, second accounts receivable data describing accounts receivable at a second point in time after the first point in time;
extracting, by the management application and from the second accounts receivable data, second updated training data for the accounts receivable model; and
retraining, by the management application, the accounts receivable model using the second updated training data.

9. The computing system of claim 8, the operations further comprising:
after retraining the accounts receivable model using the second updated training data, executing, by the management application, the accounts receivable model based on the second accounts receivable data to determine respective updated cash input positions for a portion of the plurality of time periods after the first time period;
determining, by the management application, respective updated net positions for the portion of the plurality of time periods using the respective updated cash input positions; and
sending, by the management application, a second purchase instruction to the investment system, the second purchase instruction requesting purchase of the security having a period comprising at least one time period of the portion of the plurality of time periods.

10. A computer implemented method, comprising:
receiving, by a management application executing at a hardware computing system, first accounts receivable data describing accounts receivable at a first point in time, the first accounts receivable data comprising an indication that a first account receivable was paid as of the first point in time;
extracting, by the management application and from the first accounts receivable data, updated training data for an accounts receivable model;
retraining, by the management application, the accounts receivable model using the updated training data;
after retraining the accounts receivable model, executing, by the management application, the accounts receivable model based on the first accounts receivable data to determine respective cash input positions for a plurality of time periods, the plurality of time periods being after the first point in time;
receiving, by the management application, first accounts payable data describing accounts payable at the first point in time;
determining, by the management application, respective cash output positions for the plurality of time periods using the first accounts payable data;
determining, by the management application, respective net positions for the plurality of time periods using the respective cash input positions and the respective cash output positions, a net position for a first time period of the plurality of time periods being positive, and a net position for a second time period of the plurality of time periods being positive;
determining, by the management application, a first positive tranche, the first positive tranche comprising a portion of the net position for the first time period and a portion of the net position for the second time period; and
sending, by the management application, a first purchase instruction to an investment system, the first purchase instruction requesting purchase of a security having a value corresponding to the first positive tranche and a period comprising at least the first time period and the second time period.

11. The computer implemented method of claim 10, a net position for a third time period being negative and a net position for a fourth time period after the third time period being negative.

12. The computer implemented method of claim 11, further comprising:
determining, by the management application, a first negative tranche, the first negative tranche comprising a portion of the net position for the third time period and a portion of the net position for the fourth time period; and
sending, by the management application, a first loan instruction, the first loan instruction requesting a credit amount corresponding to the first negative tranche and a credit period comprising at least the third time period and the fourth time period.

13. The computer implemented method of claim 10, the determining of the respective cash output positions for the plurality of time periods comprising executing an accounts payable model.

14. The computer implemented method of claim 13, further comprising:
extracting, by the management application and from the first accounts payable data, updated accounts payable training data for the accounts payable model; and
retraining, by the management application, the accounts payable model using the updated accounts payable training data, the executing of the accounts payable model being after the retraining.

15. The computer implemented method of claim 10, further comprising:
receiving, by the management application, nonperiodic expense data describing at least one nonperiodic expense;
training, by the management application, a nonperiodic expense model using the nonperiodic expense data; and
executing, by the management application, the nonperiodic expense model to determine respective nonperiodic expense positions for the plurality of time periods, the respective net positions for the plurality of time periods also using the respective nonperiodic expense positions.

16. The computer implemented method of claim 10, further comprising:
determining, by the management application, a second positive tranche, the second positive tranche comprising a second portion of the net position for the first point in time; and
sending, by the management application, a second purchase instruction to the investment system, the second purchase instruction requesting purchase of a second security having a value corresponding to the second positive tranche and a term comprising the first time period.

17. The computer implemented method of claim 10, further comprising:
receiving, by the management application, second accounts receivable data describing accounts receivable at a second point in time after the first point in time;
extracting, by the management application and from the second accounts receivable data, second updated training data for the accounts receivable model; and
retraining, by the management application, the accounts receivable model using the second updated training data.

18. The computer implemented method of claim 17, further comprising:
after retraining the accounts receivable model using the second updated training data, executing, by the management application, the accounts receivable model based on the second accounts receivable data to determine respective updated cash input positions for a portion of the plurality of time periods after the first time period;
determining, by the management application, respective updated net positions for the portion of the plurality of time periods using the respective updated cash input positions; and
sending, by the management application, a second purchase instruction to the investment system, the second purchase instruction requesting purchase of the security having a period comprising at least one time period of the portion of the plurality of time periods.

19. A machine-readable medium comprising instructions thereon that, when executed by at least one processor, cause the at least one processor to perform operations comprising:
receiving, by a management application executing at the at least one processor, first accounts receivable data describing accounts receivable at a first point in time, the first accounts receivable data comprising an indication that a first account receivable was paid as of the first point in time;
extracting, by the management application and from the first accounts receivable data, updated training data for an accounts receivable model;
retraining, by the management application, the accounts receivable model using the updated training data;
after retraining the accounts receivable model, executing, by the management application, the accounts receivable model based on the first accounts receivable data to determine respective cash input positions for a plurality of time periods, the plurality of time periods being after the first point in time;
receiving, by the management application, first accounts payable data describing accounts payable at the first point in time;
determining, by the management application, respective cash output positions for the plurality of time periods using the first accounts payable data;
determining, by the management application, respective net positions for the plurality of time periods using the respective cash input positions and the respective cash output positions, a net position for a first time period of the plurality of time periods being positive, and a net position for a second time period of the plurality of time periods being positive;
determining, by the management application, a first positive tranche, the first positive tranche comprising a portion of the net position for the first time period and a portion of the net position for the second time period; and
sending, by the management application, a first purchase instruction to an investment system, the first purchase instruction requesting purchase of a security having a value corresponding to the first positive tranche and a period comprising at least the first time period and the second time period.

20. The medium of claim 19, a net position for a third time period being negative and a net position for a fourth time period after the third time period being negative.
